(19) United States
(12) Patent Application Publication
(10) Pub. No.: US 2025/0014008 A1
(43) Pub. Date: Jan. 9, 2025

(54) PRODUCT REGISTRATION DEVICE AND METHOD

(71) Applicant: Toshiba Tec Kabushiki Kaisha, Tokyo (JP)

(72) Inventors: Takeshi KATO, Sunto Shizuoka (JP); Naotake HIRAMATSU, Ota Tokyo (JP)

(21) Appl. No.: 18/750,392

(22) Filed: Jun. 21, 2024

(30) Foreign Application Priority Data
Jul. 7, 2023 (JP) 2023-112541

(51) Int. Cl. G06Q 20/20; G07G 1/01

(52) U.S. Cl. CPC G06Q 20/208; G07G 1/01

(57) ABSTRACT

According to one embodiment, a product registration device is configured to receive a recognition result, register a product corresponding to a product code as a sales target in a sales transaction if the recognition result specifies a single product code as the product being registered. When the recognition result specifies one or more candidate product codes, the device identifies a candidate product code in the recognition result having a highest degree of similarity value and checks a product master database to determine whether the identified candidate product code is for a code-symbol attached product having a code symbol thereon. If the candidate product code having the highest degree of similarity value is for a code-symbol attached product, the device delays registration to permit another recognition result to be received via the communication unit before display of candidate product selection screen or the like.

### CROSS-REFERENCE TO RELATED APPLICATION

This application is based upon and claims the benefit of priority from Japanese Patent Application No. 2023-112541, filed Jul. 7, 2023, the entire contents of which are incorporated herein by reference.

### FIELD

Embodiments described herein relate to a product registration device and a method.

### BACKGROUND

In the related art, stores such as shopping centers, retail stores, and department stores have point-of-sale (POS) systems that perform product registration and other processes related to commodities on sale. Some of these POS systems recognize the product based on the features of the product depicted in an image captured by an imaging device and then perform product registration based on the recognition result.

The product recognition described above is performed by comparing stored feature values related to the appearance of each product available for sale at the store to the feature values of the product extracted from the acquired image of the product. Generally, the result of the recognition is output as a degree of similarity, which is a measure of a match between a known product sold in the store and the imaged product. A product having a degree of similarity that is equal to or greater than some threshold value (e.g., 95% or more) is considered as being definitively matched to a known (reference) product.

If no product exceeds the degree of similarity threshold value, a predetermined number of products with the highest degrees of similarity are extracted as candidate products, and a screen (hereinafter, referred to as a ‘product selection screen’) for selecting one product from the candidate products is displayed, thus allowing the operator to select the correct product.

However, the operation of selecting the correct product from among a plurality of candidate products with similar appearance is a cumbersome and time-consuming task for an operator who is inexperienced. Under these circumstances, it is desirable to reduce display occurrences of the product selection screen so as to improve the efficiency of the product registration.

### BRIEF DESCRIPTION OF THE DRAWINGS

FIG. 1 is a diagram illustrating an example of a product sales data processing system according to an embodiment.

FIG. 2 is a diagram illustrating an example of package recognition.

FIG. 3 is a diagram illustrating an example of a hardware configuration of a POS terminal.

FIG. 4 is a diagram illustrating an example of a data configuration of a product master.

FIG. 5 is a diagram illustrating an example of the hardware configuration of an imaging device.

FIG. 6 is a diagram illustrating an example of the hardware configuration of an edge device.

FIG. 7 is a diagram illustrating an example of the hardware configuration of a store server.

FIG. 8 is a diagram illustrating an example of functional aspects of a POS terminal, an imaging device, and an edge device.

FIG. 9 is a diagram illustrating an example of a product selection screen displayed on a POS terminal.

FIG. 10 is a sequence diagram illustrating processes executed in a product sales data processing system.

FIG. 11 is a flowchart illustrating an example of product registration performed by a POS terminal.

FIG. 12 is a diagram illustrating an example of a confirmation screen displayed on a POS terminal.

### DETAILED DESCRIPTION

A product registration device and a method are provided which can improve the efficiency of processing related to product registration.

In general, according to one embodiment, a product registration device includes a communication unit and a processor. The processor is configured to receive a recognition result via the communication unit and register a product corresponding to a product code as a sales target in a sales transaction if the recognition result specifies a single product code as the product being registered. When the recognition result specifies one or more candidate product codes for the product being registered in the sales transaction, the processor identifies a candidate product code in the recognition result having a highest degree of similarity value and checks a product master database to determine whether the identified candidate product code is for a code-symbol attached product having a code symbol thereon. If the candidate product code having the highest degree of similarity value is for a code-symbol attached product, the processor delays registration to permit another recognition result to be received via the communication unit.

Hereinafter, certain example embodiments of the present disclosure will be described with reference to the accompanying drawings. In the embodiments described below, a product sales data processing device with which a customer himself or herself performs the registration operation is used as one example. It is to be noted that embodiments are not limited to the specific examples described below.

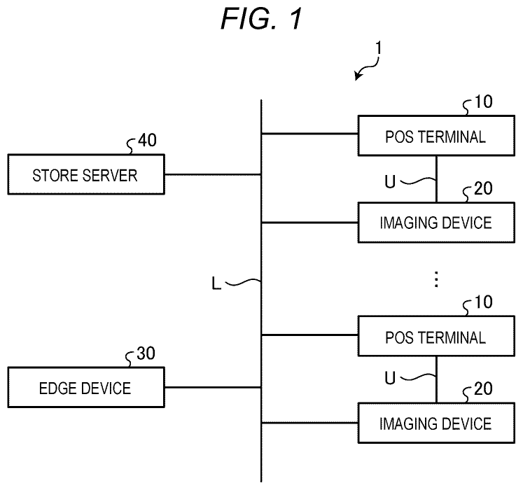

FIG. 1 is a diagram illustrating an example of a product sales data processing system according to an embodiment. In FIG. 1, a product sales data processing system 1 is installed in a store such as a supermarket, a retail store, a convenience store, a specialty store, or the like. The product sales data processing system 1 includes one or a plurality of Point of Sales (POS) terminals 10 (product sales data processing devices), an imaging device 20, an edge device 30, and a store server 40.

The POS terminal 10, the edge device 30, and the store server 40 are connected to a communication line L such as a local area network (LAN) that allows them to communicate with (notify) each other. Further, one or a plurality of imaging devices 20 are connected to each POS terminal 10 by a universal serial bus (USB) cable U, or the like. Further, the imaging device 20 can be connected to the communication line L. It is to be noted that the imaging device 20 may be configured to be connected to the communication line L via the POS terminal 10.

The imaging device 20 is equipped with an imaging element such as a charge coupled device (CCD) or complementary metal oxide semiconductor (CMOS). For example, the imaging device 20 is provided to face a customer who is operating the POS terminal 10, and images a product purchased by the customer. Specifically, in the present embodiment, since the customer operating the POS terminal 10 performs registration, the customer holds the products which he/she purchases over the imaging device 20 one by one so that the imaging device 20 images the products.

When the imaging device 20 acquires an image (hereinafter also referred to as a ‘captured image’) by imaging, the imaging device 20 outputs the acquired captured image to the edge device 30. Specifically, the imaging device 20 outputs images captured at a predetermined frame rate to the edge device 30.

Furthermore, the imaging device 20 also attempts to detect symbols, such as barcodes and two-dimensional codes, in the images by performing code recognition. In code recognition, symbols such as barcode or two-dimensional code that have been attached to the product can be detected, and decoded information obtained by decoding the detected symbol is output to the POS terminal 10. Since the decoded information includes product specifying information, the imaged product can be identified based on the product specifying information. In this embodiment, a product code is used as the product specifying information, but any information other than the product code may be used as long as the information can identify the product.

In addition, the imaging device 20 may extract particular images showing (or possibly showing) a product and use these images as target images for outputting to the edge device 30 and for symbol extraction. In this case, the method of image extraction is not particularly limited, and any known technique may be used. For example, the imaging device 20 may detect, from differences between consecutive frames, a movement of an object included in the image, extract an image in which the movement is detected, and use the image as a target for additional processing.

The edge device 30 is an information processing device that performs image processing and/or image recognition. Specifically, the edge device 30 in this example performs package recognition to recognize the product in the image sent from the imaging device 20.

The package recognition is a technology that identifies the product based on the features of the appearance of the product shown in the image acquired by the imaging device 20. The features of the appearance of the product include the package design, pattern, color, texture, shape, etc., for example.

For the package recognition, any known technique of generic object recognition or image recognition using a model such as deep learning may be used. The package recognition identifies, based on characteristic feature data of the appearance of the product from extracted the image, a corresponding product (or products) with similar feature data expressed as a degree of similarity (also referred to as a match probability, likelihood, or the like). The matching or potential matching may be based on the degree of similarity being equal to or greater than a threshold value.

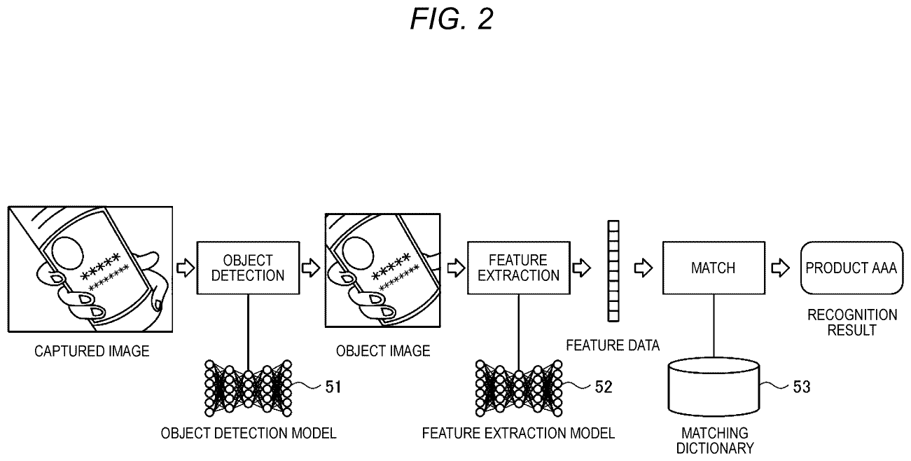

FIG. 2 is a diagram illustrating an example of package recognition. As illustrated in FIG. 2, the package recognition identifies products from the images captured by the imaging device 20. The package recognition in this example uses trained models and dictionary data (collectively referred to as ‘dictionaries’) including an object detection model 51, a feature extraction model 52, and a matching dictionary 53.

The object detection model 51 detects a region corresponding to the presence of an object appearing in the captured image. When the captured image from the imaging device 20 is input thereto, the object detection model 51 detects a region (hereinafter also referred to as an ‘object image’) in which the product is shown and outputs the result (the object image).

The feature extraction model 52 for extracting, from the region (object image) detected by the object detection model 51, the feature data indicating the characteristic features of the appearance of the product in the region. When the object image or the captured image including the object image is input thereto, the feature extraction model 52 extracts feature data of the product shown in the object image and outputs the result.

The matching dictionary 53 is for identifying a product with similar feature data (appearance) to the product in the object image. For example, the matching dictionary 53 stores a library of products sold in the store by product code in association with characteristic feature data. The matching dictionary 53 calculates a degree of similarity that quantitatively indicates how similar a stored one of the products in the library is to the imaged product. The degree of similarity can be calculated by comparing the input feature data with the stored feature data. The higher the degree of similarity, the higher the degree of resemblance between the imaged product and the reference/library product (that is, the probability that the stored product is the imaged product). As an example, a product with a degree of similarity of 95% or more is very likely to be the same product as the imaged product.

The edge device 30 uses the object detection model 51 to detect a region in the captured image showing the product. Then, the edge device 30 uses the feature extraction model 52 to extract the feature data that quantitatively represents the appearance of the product appearing in the region (object image) using multidimensional vectors, or the like. Then, the edge device 30 uses the matching dictionary 53 to calculate the degree of similarity by matching the extracted feature data with the characteristic feature data of a plurality of products stored in a dictionary or library, and the product may be recognized according to the degree of similarity.

Specifically, when there is just one product with a degree of similarity equal to or greater than a threshold value (e.g., 95% or more), the edge device 30 specifies this product as the product that was imaged by the imaging device 20. If there is no product for which the degree of similarity is equal to or greater than the threshold value (e.g., when all library products have a degree of similarity less than 95%), the edge device 30 selects a plurality of products with the highest degrees of similarity as candidate products without specifying any single product as the imaged product. For example, when the degrees of similarity of all products are less than the threshold value, the edge device 30 extracts a predetermined number (e.g., four) of candidate products from those with the high degrees of similarity. The edge device 30 then provides the product code of the specified product or a candidate product as a recognition result of the package recognition, and transmits the result to the imaging device 20 that sent the captured image. When the edge device 30 recognizes a plurality of candidate products, the edge device 30 includes the degree of similarity calculated for each of the candidate products in the recognition result. The edge device 30 may include the degree of similarity even when able to uniquely specify a product. The edge device 30 may have a lower limit threshold value and exclude the products having a degree of similarity below the lower limit threshold value from the candidate products.

Upon receiving the package recognition result from the edge device 30, the imaging device 20 outputs the recognition result to the POS terminal 10. It is to be noted that the imaging device 20 may output a code recognition result it has obtained and/or the package recognition result from the edge device 30 to the POS terminal 10. The recognition result provided to the POS terminal 10 may specify whether the product code therein was obtained by code recognition or package recognition in an identifiable manner. For example, the imaging device 20 may output, together with the recognition result, a flag value that can identify the recognition method as code recognition or package recognition.

It is to be noted that, in this present embodiment, the edge device 30 outputs the recognition result of the package recognition to the POS terminal 10 via the imaging device 20, but embodiments are not limited thereto, and the edge device 30 may be configured to output directly to the POS terminal 10. In this case, the edge device 30 may store setting information that associates the IP addresses of the paired POS terminal 10 and the imaging device 20, and transmit the package recognition result to the POS terminal 10 corresponding to the imaging device 20 that initially transmitted the captured image.

The store server 40 can be installed in the back room of the store, for example. The store server 40 stores a product master in which the product name, price, product image, etc. of each product sold in the store are associated with a product code. In addition, the store server 40 provides the product master to each POS terminal 10. For example, the store server 40 transmits the product master to each POS terminal 10 and to be stored locally in the POS terminal 10. In some examples, the store server 40 stores the product master such that each POS terminal 10 can refer to the same product master.

The store server 40 also collects sales data received from the POS terminal 10. The store server 40 tracks sales of products at the store based on the collected sales data.

The POS terminal 10 in this example cooperates with other devices to perform registration of, and payment for, the products sold in the store. In this example, the POS terminal 10 is operated by the customer and executes the registering of a product based on the images captured by the imaging device 20 when the customer holds the product over the imaging device 20. In response to an operation of instructing the end of the registration process, the POS terminal 10 executes a payment process in which the price of the products registered is paid by the customer.

For example, one or a plurality of (e.g., three in FIG. 1) POS terminals 10 are installed in the checkout area of the store. The POS terminal 10 is a product sales data processing device that can be operated by the customer himself/herself. When the customer performs holds the product to be purchased over the imaging device 20, the POS terminal 10 executes a product registration process for the product to be purchased based on the product code of the product as recognized by the code recognition or the package recognition described above. In this context, product registration refers to a process of reading, from the product master, the product information (product name, price of the product, etc.) of the product corresponding to the product code, and storing the result in the RAM 13, or the like.

Further, in response to an instruction to end the product registration or start the payment process, the POS terminal 10 executes the payment process for the products registered by the product registration. In this context, the payment process refers to the settlement (closing) process for the transaction based on the product information registered by the product registration. In the payment process, a total amount due for the transaction is displayed on a display unit 16 and then payment using cash, credit cards, or electronic money is selected and performed. The payment process also includes calculating, displaying, and returning change due in the case of cash payment. The payment process may also include the issuing of a receipt printed with the product information and transaction accounting information (total amount, deposit amount, change amount, reward point information, etc.) from a printer 18.

The POS terminal 10 also transmits, to the store server 40, the product information and the accounting information (also collectively referred to as ‘sales data’) for the products subjected to the payment. In an embodiment, the transmission of the sales data from the POS terminal 10 to the store server 40 may be performed when the payment is completed, but embodiments are not limited thereto, and in other examples, the sales data for an entire day may be transmitted at once, such as when the store is closed for the day.

As described above, in the product sales data processing system 1 of this embodiment, identifying the product based on the captured images is performed by using either or both code recognition and package recognition in combination. Each of the POS terminals 10 performs the product registration using the result of the code recognition and package recognition performed using the images captured by the imaging device 20 connected to the POS terminal 10.

The configuration of each device included in the product sales data processing system 1 will now be explained.

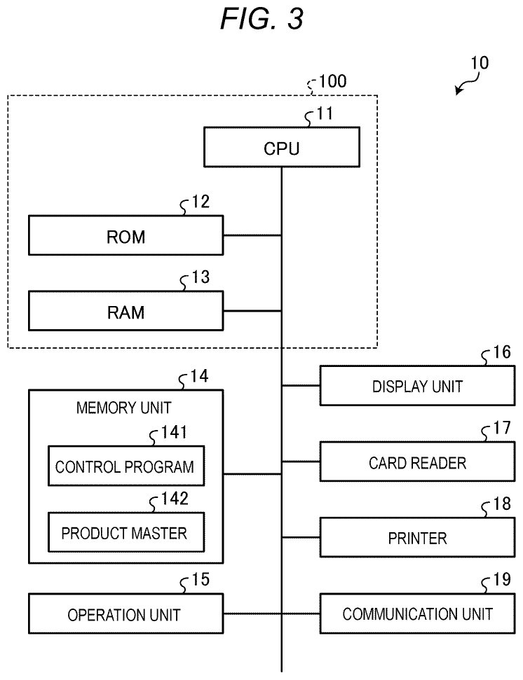

FIG. 3 is a diagram illustrating an example of a hardware configuration of the POS terminal 10. As illustrated in FIG. 3, the POS terminal 10 includes a Central Processing Unit (CPU) 11 as an example of the processor, a Read Only Memory (ROM) 12, a Random Access Memory (RAM) 13, a memory unit 14, and the like.

The CPU 11 includes one or a plurality of processing circuits, and collectively controls the operations of the POS terminal 10. The ROM 12 stores various programs that can be executed by the CPU 11. The RAM 13 is a work area for temporarily storing programs and various data. For example, the RAM 13 stores the recognition result of the code recognition or package recognition, the product codes of the products subjected to the product registration, and the like.

The memory unit 14 includes a non-volatile memory such as a Hard Disc Drive (HDD), a flash memory, and the like, that retains stored information even when the power is turned off. The memory unit 14 stores various programs that can be executed by the CPU 11, setting information, and the like. For example, the memory unit 14 stores a control program 141 that can be executed by the CPU 11, a product master 142, and the like. The product master 142 stores the product information and the like of the product corresponding to the product code, in association with the product code of each product sold in the store.

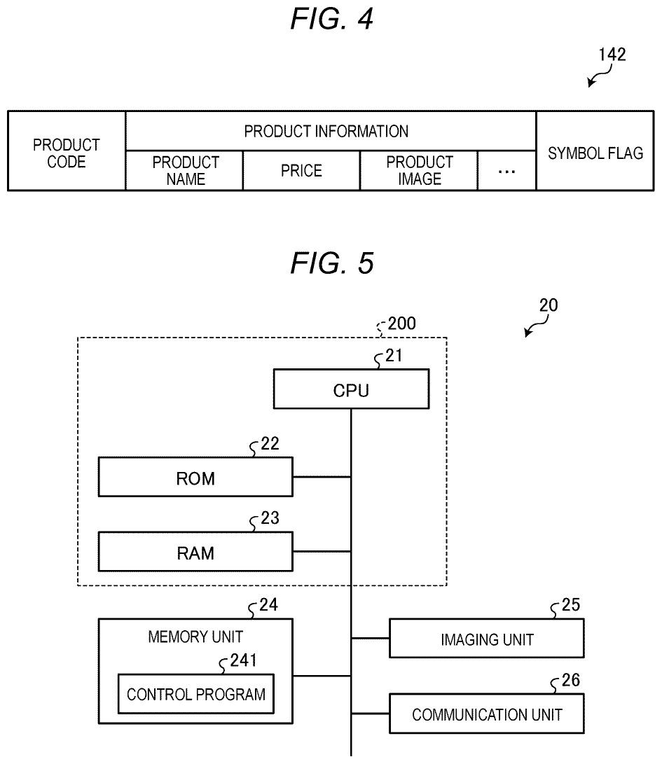

FIG. 4 is a diagram illustrating an example of the data configuration of the product master 142. As illustrated in FIG. 4, the product master 142 stores the product information and symbol flag of a product corresponding to the product code in association.

The product information includes various types of information about the product. For example, the product information includes a product name, a price, and a product image. In this context, a product image is image data reflecting the nominal appearance of the product or the like. The symbol flag is binary flag value indicating whether or not the product is attached to a symbol (e.g., whether the product is expected to have a barcode thereon or affixed thereto).

A product with a symbol attached may be subjected to code recognition but also to package recognition. On the other hand, a product without a symbol can not be subjected to the code recognition and may be recognized only through the package recognition. Examples of products without symbols include fresh foods (e.g., fruits and vegetables) and prepared foods manufactured at the store.

Returning to FIG. 3, the CPU 11, the ROM 12, the RAM 13, and the memory unit 14 are connected to each other via a bus, or the like. The CPU 11, the ROM 12, and the RAM 13 form a control unit 100 of the POS terminal 10. The control unit 100 implements described functions of the POS terminal 10 by the CPU 11 operating according to the control program 141 stored in the ROM 12 or the memory unit 14 and then loaded into the RAM 13.

Further, the control unit 100 is connected to an operation unit 15, a display unit 16, a card reader 17, a printer 18, and other units/devices via a bus, or the like.

The operation unit 15 includes various operation keys for the operator to make input operations. The operation unit 15 includes a close key as one example of an operation key. The close key is operated to cause the POS terminal 10 to finish the product registration and then proceed to the payment. For example, the display unit 16 is a liquid crystal display and displays information for the customer who is the operator of the POS terminal 10. Under the control of the control unit 100, the display unit 16 displays the product information (product name, product price, etc.) of the products registered in the product registration and accounting information related to payment. In addition, the operation unit 15 may be or include a touch panel provided on the display screen of the display unit 16.

The card reader 17 is for performing payment using a credit card, a debit card, an electronic money card, etc. The card reader 17 is a reading device for reading information related to the payment from the card. The printer 18 is a printing device such as a thermal printer. The printer 18 issues a receipt printed with the product information, the payment information, and other information related to the products subjected to the payment. The printer 18 operates under the control of the control unit 100.

The control unit 100 is connected to a communication unit 19 via a bus, or the like. The communication unit 19 can be one or more of a variety of communication interfaces for connecting to external devices. The communication unit 19 is communicatively connected to the imaging device 20 via the cable U. Further, the communication unit 19 is communicatively connected to the edge device 30 and the store server 40 via the communication line L.

The hardware configuration of the imaging device 20 will now be explained. FIG. 5 is a diagram illustrating an example of the hardware configuration of the imaging device 20. As illustrated in FIG. 5, the imaging device 20 includes a CPU 21 (a processor), a ROM 22, a RAM 23, a memory unit 24, and the like.

The CPU 21 includes one or a plurality of processing circuits and collectively controls the operations of the imaging device 20. The ROM 22 stores various programs that can be executed by the CPU 21. The RAM 23 is a work area for temporarily storing programs and various data. For example, the RAM 23 stores images captured by an imaging unit 25, intermediate data of the code recognition, processing result (the result of the recognition), and the like.

The memory unit 24 includes a non-volatile memory such as an HDD, a flash memory, or the like that retains stored information even when the power is turned off. The memory unit 24 stores various programs that can be executed by the CPU 21, setting information, and the like. For example, the memory unit 24 stores a control program 241 that can be executed by the CPU 21.

The CPU 21, the ROM 22, the RAM 23, and the memory unit 24 are connected to each other via a bus or the like. The CPU 21, the ROM 22, and the RAM 23 form a control unit 200 of the imaging device 20. The control unit 200 implements described functions of the imaging device 20 by the CPU 21 operating according to the control program 241 that is stored in the ROM 22 or the memory unit 24 and loaded into the RAM 23.

The control unit 200 is connected to the imaging unit 25 and a communication unit 26 via a bus or the like. The imaging unit 25 can be a camera module equipped with an imaging element such as a CCD. The communication unit 26 can be one or more of a variety of communication interfaces for connecting to external devices. The communication unit 26 is communicatively connected to the POS terminal 10 via the cable U.

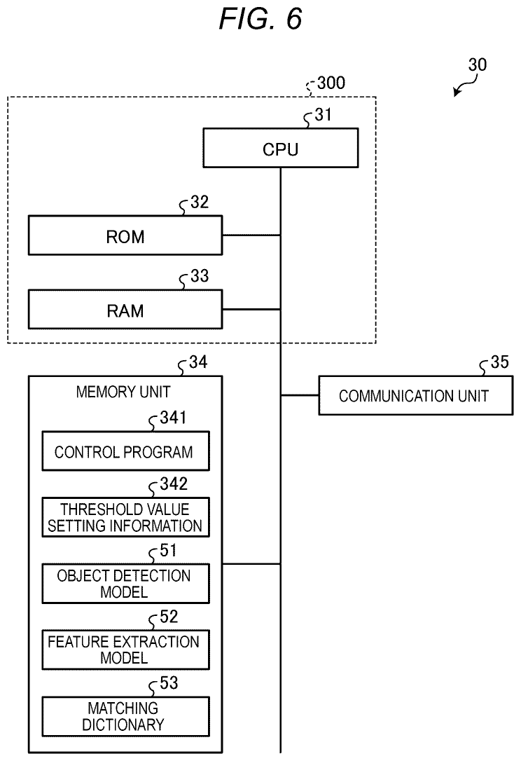

The hardware configuration of the edge device 30 will now be explained. FIG. 6 is a diagram illustrating an example of the hardware configuration of the edge device 30. As illustrated in FIG. 6, the edge device 30 includes a CPU 31 (a processor), a ROM 32, a RAM 33, and a memory unit 34.

The CPU 31 includes one or a plurality of processing circuits and collectively controls the operations of the edge device 30. The ROM 32 stores various programs that can be executed by the CPU 31. The RAM 33 is a work area for temporarily storing programs and various data. For example, the RAM 33 stores images transmitted from the imaging device 20, intermediate data of the package recognition, processing result (result of the recognition), and the like.

The memory unit 34 includes a non-volatile memory such as an HDD, a flash memory, or the like that retains stored information even when the power is turned off. The memory unit 34 stores various programs that can be executed by the CPU 31, setting information, and the like. For example, the memory unit 34 stores a control program 341 that can be executed by the CPU 31. In addition to the object detection model 51, the feature extraction model 52, and the matching dictionary 53 described above, the memory unit 34 stores threshold value setting information 342 in which a threshold value is set as an index for considering a produce to be uniquely specified (identified) g based on the degree of similarity.

The CPU 31, the ROM 32, the RAM 33, and the memory unit 34 are connected to each other via a bus or the like. The CPU 31, the ROM 32, and the RAM 33 form the control unit 300 of the edge device 30. The control unit 300 implements described functions of the edge device 30 by the CPU 31 operating according to the control program 341 that is stored in the ROM 32 or the memory unit 34 and then loaded into the RAM 33.

The control unit 300 is connected to a communication unit 35 via a bus or the like. The communication unit 35 can be more of a variety of communication interfaces for connecting to external devices. The communication unit 35 is communicatively connected to the POS terminal 10, the imaging device 20, and the store server 40 via the communication line L.

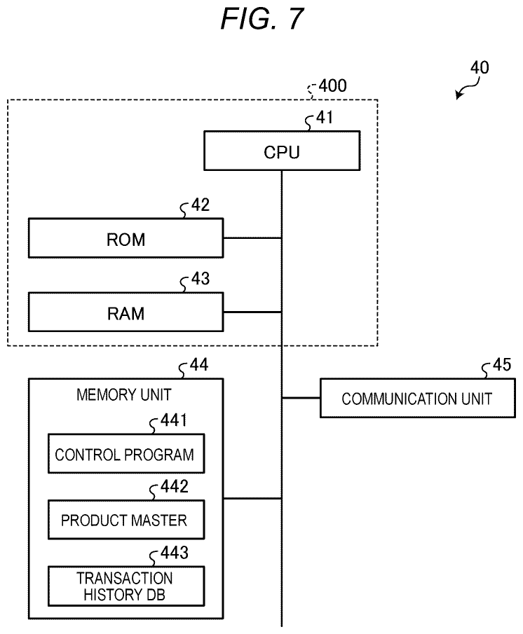

The hardware configuration of the store server 40 will now be explained. FIG. 7 is a diagram illustrating an example of the hardware configuration of the store server 40. As illustrated in FIG. 7, the store server 40 includes a CPU 41 as an example of the processor, a ROM 42, a RAM 43, and a memory unit 44.

The CPU 41 includes one or a plurality of processing circuits and collectively controls the operations of the store server 40. The ROM 42 stores various programs that can be executed by the CPU 41. The RAM 43 is a work area for temporarily storing programs and various data. For example, the RAM 43 temporarily stores accounting data transmitted from the POS terminal 10.

The memory unit 44 includes a non-volatile memory such as an HDD, a flash memory, or the like that retains stored information even when the power is turned off. The memory unit 44 stores various programs that can be executed by the CPU 41, setting information, and the like. For example, the memory unit 44 stores a control program 441 that can be executed by the CPU 41. The memory unit 44 also stores a product master 442, a transaction history database (DB) 443 for storing and managing the accounting data, and the like. It is to be noted that the product master 442 is similar to the product master 142. By providing a product master 442 to each POS terminal 10, the product master 442 can be used as the product master 142 in each POS terminal 10.

The CPU 41, the ROM 42, the RAM 43, and the memory unit 44 are connected to each other via a bus, or the like. The CPU 41, the ROM 42, and the RAM 43 form a control unit 400 of the store server 40. The control unit 400 implements described functions of the store server 40 by the CPU 41 operating according to the control program 441 that is stored in the ROM 42 or the memory unit 44 and loaded into the RAM 43.

The control unit 400 is connected to a communication unit 45 via a bus or the like. The communication unit 45 can be one or more of a variety of communication interfaces for connecting to external devices. The communication unit 45 is communicatively connected to the POS terminal 10 via the communication line L.

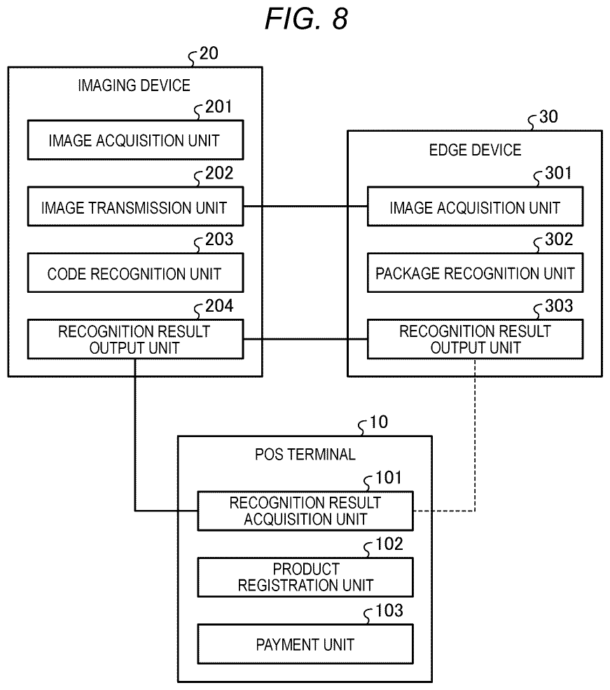

The functional aspects of the POS terminal 10, the imaging device 20, and the edge device 30 will now be explained. FIG. 8 is a diagram illustrating an example of functional aspects of the POS terminal 10, the imaging device 20, and the edge device 30.

As illustrated in FIG. 8, the imaging device 20 provides the functions of an image acquisition unit 201, an image transmission unit 202, a code recognition unit 203, and a recognition result output unit 204.

The functions of imaging device 20 can result from a software configuration implemented by the processor of the imaging device 20 operating according to the control program 241, although embodiments are not limited thereto. For example, some or all of the functions of the imaging device 20 may be implemented by hardware such as a dedicated circuit.

The image acquisition unit 201 acquires an image from the imaging unit 25. In addition, the image acquisition unit 201 may extract, from the images acquired by the imaging unit 25 by the known techniques such as motion detection, an image showing or possibly showing a product therein.

The image transmission unit 202 transmits the image acquired by the image acquisition unit 201 to the edge device 30. The code recognition unit 203 attempts to detect a symbol (such as a barcode) in the image acquired by the image acquisition unit 201 by performing code recognition on the image. When the code recognition unit 203 detects a symbol in the image, the code recognition unit 203 then decodes the symbol to acquire decoded information including the product code as a recognition result of the code recognition.

The recognition result output unit 204 outputs the recognition result of the code recognition unit 203 to the POS terminal 10. The recognition result output unit 204 may also or instead output the recognition result of a package recognition that has been received from the edge device 30 to the POS terminal 10. The recognition result output unit 204 may output the results of the code recognition or package recognition, with a flag value indicating the recognition method providing the result so that the recognition method can be identified.

As illustrated in FIG. 8, the edge device 30 provides the functions of an image acquisition unit 301, a package recognition unit 302, and a recognition result output unit 303.

The functions of the edge device 30 can result from a software configuration implemented by the processor of the edge device 30 operating according to the control program 341, although embodiments are not limited thereto. For example, some or all of the functions of the edge device 30 may be implemented by hardware such as a dedicated circuit.

The image acquisition unit 301 acquires images from the imaging devices 20 via the communication unit 45. The package recognition unit 302 attempts to detect an object image and/or to extract the feature data from an image by performing the package recognition as described above on the image acquired by the image acquisition unit 301. When, on the basis of the feature data extracted from an image, the package recognition unit 302 confirms that there is just one product with a degree of similarity equal to or greater than the threshold value in the matching dictionary 53, the package recognition unit 302 outputs the product code of this product as the recognition result. When there is no product with a degree of similarity equal to or greater than the threshold value, the package recognition unit 302 extracts a predetermined number of products with high degrees of similarity from the matching dictionary 53 and outputs a recognition result in which the product code of each extracted product (candidate products) is associated with the calculated degree of similarity of the product.

When there are multiple products having a degree of similarity equal to or greater than the threshold value, the package recognition unit 302 outputs a recognition result in which the product codes of these products are associated with the degrees of similarity of the products.

The recognition result output unit 303 outputs the recognition result of the package recognition to an external device corresponding to the transmission source of the recognition-processed image. Specifically, in this example, the recognition result output 303 unit transmits the package recognition result to the imaging device 20 that sent the image via the communication unit 45. The recognition result output unit 303 may transmit the recognition result to the POS terminal 10 corresponding to the imaging device 20 instead or in addition.

The POS terminal 10 provides the functions of a recognition result acquisition unit 101, a product registration unit 102, and a payment unit 103, as illustrated in FIG. 8.

The functions of the POS terminal 10 can be provided by a software configuration implemented by the processor of the POS terminal 10 operating according to the control program 141, although embodiments are not limited thereto. For example, some or all of the functions of the POS terminal 10 may be implemented by hardware such as a dedicated circuit.

The recognition result acquisition unit 101 is an example of a first acquisition unit and a second acquisition unit. The acquisition unit 101 acquires the recognition results of a code recognition and/or a package recognition as such may be performed by the imaging device 20 and the edge device 30. Specifically, in this example, the recognition result acquisition unit 101 acquires the code recognition and package recognition results transmitted from the imaging device 20 via the communication unit 19. If the package recognition result is directly transmitted from the edge device 30 (the recognition result output unit 303) to the POS terminal 10 (see the broken line in the drawing), the recognition result acquisition unit 101 may acquire the package recognition result directly from the edge device 30 rather than via the imaging device 20.

The product registration unit 102 is an example of a registration unit and a display unit. The product registration unit 102 executes product registration for a product being purchased by the customer based on the recognition result(s) acquired by the recognition result acquisition unit 101. In other words, the product registration unit 102 executes the product registration based on the recognition result from code recognition and/or package recognition performed on an image of the product obtained by imaging device 20.

Specifically, when the product is uniquely specified by the recognition result of either code recognition or package recognition, that is, when the product code of only one product is included in the recognition result, the product registration unit 102 executes the product registration for this product. The product registration unit 102 can speed up the registration process by performing product registration using whichever recognition result is acquired first.

If the recognition result of the package recognition includes a plurality of product codes and no result from the code recognition is acquired, the product registration unit 102 attempts product registration based on the package recognition result.

In the related art, when product registration using generic object recognition is performed and a plurality of product codes are provided as candidate products, a product selection screen from which one of these candidate products can be selected by an operator is displayed on the display device, thereby allowing the operator to select the correct product from among the identified candidates. However, generally, the operation of selecting the correct product from among a plurality of candidate products, typically with very similar appearances, is a cumbersome and time-consuming task, especially for an operator who is inexperienced with operating self-registration devices or the like. Under these circumstances, it is desirable to reduce how often (display occurrences) the product selection screen must be displayed so as to improve the efficiency and speed of the product registration at the store.

In the present embodiment, the product registration unit 102 aims to speed up the product registration by reducing the number of display occurrences of the product selection screen even though a plurality of candidate products may have been recognized.

Specifically, in the present embodiment, the product registration unit 102 determines, based on information other than just the image captured by the imaging device 20, whether any of the candidate products are products to which a symbol is attached, and then decides whether or not to go ahead and display the product selection screen or to continue attempting a code recognition or another package recognition.

In this embodiment, the product registration unit 102 determines, with reference to the symbol flag in the product master 142, whether any of the candidate products are attached to a symbol or not.

For example, the product registration unit 102 specifies, by reference to the degree of similarity corresponding to each product code in the recognition result, the product code with the highest degree of similarity. Then, the product registration unit 102 checks (by reference to the symbol flag in the product master 142) whether the specified product code is attached to a symbol.

If, according to the symbol flag, a symbol is attached to this candidate product, the product registration unit 102 waits for the product to be uniquely specified by code recognition (or continued/additional the package recognition processing) without displaying the product selection screen. The product registration unit 102 may also cause the display unit 16 to display a message prompting the user to check whether or not a symbol is attached to the product, a message guiding the user to direct the symbol toward the imaging device 20, etc. As a result, when the symbol is on the product currently held in the customer's hand, it is possible to prompt the customer to continue to attempt to have the symbol read (or the product otherwise identified), thereby speeding up the product registration by avoiding display of the product selection screen unnecessarily.

On the other hand, if, according to the symbol flag of the candidate product, no symbol is attached thereto, the product registration unit 102 causes the display unit 16 to go ahead and display the product selection screen based on the product information corresponding to the product codes included in the recognition result.

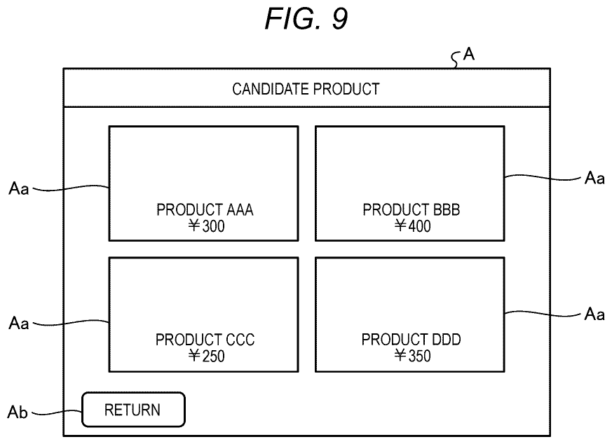

FIG. 9 is a diagram illustrating an example of a product selection screen A displayed on the POS terminal 10. As illustrated in FIG. 9, the product selection screen A includes display areas Aa for displaying products corresponding to each product code corresponding to the candidate products.

In each display area Aa, the product name, price, product image, etc. of a candidate product are displayed. In FIG. 9, four candidate products are illustrated, and a display area Aa is provided for each candidate product. It is to be noted that in the product selection screen A, the arrangement positions of the candidate products are not particularly limited, although it may be preferable to arrange them according to a ranking of degree of similarity. For example, the items may be arranged in the ranking order from top left, top right, bottom left, and bottom right in descending order of degree of similarity.

The display area Aa also serves as an operator (button) for selecting the candidate product to be registered. When one of the display areas Aa is selected by the customer, the product registration unit 102 executes the product registration based on the product code corresponding to the candidate product of the selected display area Aa. Then, the product registration unit 102 erases the product selection screen A.

The product selection screen A also includes a return button Ab. When receiving the operation of the return button Ab, the product registration unit 102 erases the product selection screen A and waits until a new recognition result is acquired.

In one configuration, the product selection screen A might not display those candidate products for which symbol flags indicate should have symbols attached thereto. As a result, it is possible to reduce the number of candidate products displayed on the product selection screen A and improve the user's recognition speed and operability, thereby increasing the efficiency of the product registration.

Furthermore, the product registration unit 102 may keep waiting for a recognition result by code recognition even when the product selection screen A is being displayed. As a result, the product registration unit 102 can continue attempting the product registration using the code recognition even when candidate products recognized through package recognition are displayed on the product registration unit 102, and thus may perform the product registration more promptly if the product can instead be uniquely specified by the code recognition process. In this case, it is preferable to display, on the product selection screen A, a message, or the like informing the operator that it is still possible for the symbol (barcode) to be read from the product rather than requiring a candidate selection from the operator.

Returning to FIG. 8, the payment unit 103 executes a process (payment) related to payment for the product registered in the product registration in response to the customer's operation. The payment may be performed by at POS terminal 10 or may be performed in cooperation with other separate devices (e.g., an accounting device, a payment server, etc.).

For example, when the payment unit 103 receives an operation to instruct the start of payment via the operation unit 15, the payment unit 103 causes the display unit 16 to display a screen from which a payment method (e.g., cash payment, electronic money payment, and credit card payment) can be selected. When cash payment is selected, the payment unit 103 executes the payment by the payment amount being deposited via a deposit device (cash payment handling machine), or the like. Further, when electronic money payment or credit card payment is selected, the payment unit 103 receives an input of payment information for performing the payment using the selected payment method, and cooperates with an external payment server as necessary to execute the payment based on the input payment information. Such payment information may be a credit card number or a two-dimensional code for the code payment, for example. It is to be noted that in the case of a two-dimensional code for the code payment, input may be accepted via the imaging device 20.

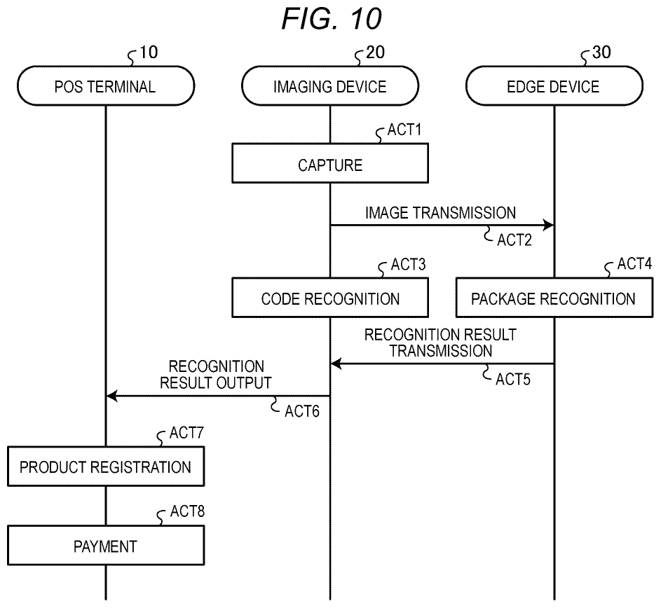

The flow of processing executed by the product sales data processing system 1 will now be explained. FIG. 10 is a sequence diagram illustrating an example of the processes executed in the product sales data processing system 1.

First, the customer performs the registration operation at the POS terminal 10 by holding the product to be purchased over the imaging device 20. The image acquisition unit 201 of the imaging device 20 acquires an image captured by the imaging unit 25 (ACT 1). Then, the image transmission unit 202 of the imaging device 20 transmits the image to the edge device 30 (ACT 2). Further, the code recognition unit 203 of the imaging device 20 also performs code recognition on the image (ACT 3).

After the image is transmitted by the imaging device 20, the package recognition unit 302 of the edge device 30 performs package recognition on the image (ACT 4). When the product is uniquely recognized or a plurality of candidate products are recognized through the package recognition, the recognition result output unit transmits the recognition result to the imaging device 20 (ACT 5).

Upon receiving the recognition result from the edge device 30, the recognition result output unit 204 of the imaging device 20 outputs the recognition result to the POS terminal 10 (ACT 6). If the product is recognized by the code recognition, the code recognition unit 203 outputs the recognition result to the POS terminal 10 (ACT 6).

In addition, when the product is imaged in the customer's registration operation, the product enters the imaging range of the imaging device 20 starting from the edge thereof. Therefore, there is generally a high possibility that the package recognition to the POS terminal 10 occurs first and is therefore output first, and the code recognition and output occurs later. However, the order of outputting the recognition results of the code recognition and the package recognition is not limited thereto.

When a recognition result is sent from the imaging device 20, the product registration unit 102 of the POS terminal 10 executes the product registration based on the recognition result (ACT 7). The POS terminal 10, the imaging device 20, and the edge device 30 execute the processes of ACTs 1 to 7 each time the customer performs a product registration operation (e.g., passes a held product through the imaging range of the imaging device 20). Then, after the customer instructs the end of the product registration process, the payment unit 103 of the POS terminal 10 executes the payment process (ACT 8).

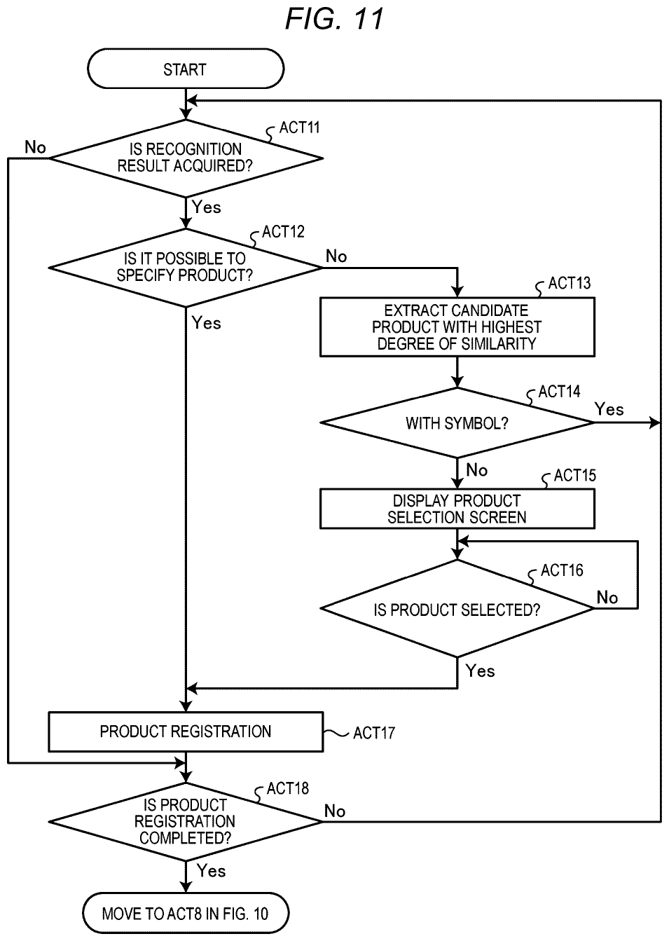

The processing performed by the POS terminal 10 will now be described with reference to FIG. 11. FIG. 11 is a flowchart illustrating an example of the product registration performed by the POS terminal 10. It is to be noted that this processing corresponds to ACT 7 in FIG. 10.

First, the recognition result acquisition unit 101 determines whether or not a recognition result has been acquired from the imaging device 20 (ACT 11). When the recognition result is not yet acquired (ACT 11; No), the process proceeds to ACT 18. When the recognition result acquisition unit 101 acquires the recognition result from the imaging device 20 (ACT 11; Yes), the process proceeds to ACT 12.

The product registration unit 102 next determines whether or not the product can be uniquely specified based on the acquired recognition result (ACT 12). Specifically, the product registration unit 102 determines whether or not if just a single product code, as recognized by the code recognition or the package recognition, is included in the recognition result.

When determining that the product can be uniquely specified (ACT 12; Yes), the product registration unit 102 executes the product registration based on the single product code included in the recognition result (ACT 17), and proceeds to ACT 18. In addition, when the product registration unit 102 executes the product registration, the product registration unit 102 causes the display unit 16 to display a product registration screen that displays information such as the product name and price of the registered products in the order of registration.

On the other hand, when determining that the product cannot be uniquely specified (ACT 12; No), that is, when the recognition result includes the product codes of a plurality of candidate products, the process proceeds to ACT 13. In ACT 13, the product registration unit 102 extracts the product code of the candidate product with the highest degree of similarity (ACT 13). Then, the product registration unit 102 determines, by reference to the product master 142, whether or not the symbol flag of the extracted highest similarity product code indicates “With Symbol” (ACT 14).

In this embodiment, when the symbol flag indicates “With Symbol” (ACT 14; Yes), the product registration unit 102 returns the process to ACT 11, thereby making it possible to acquire the recognition result by code recognition or otherwise.

On the other hand, when the symbol flag indicates “Without Symbol” (ACT 14; No), the product registration unit 102 causes the display unit 16 to display a product selection screen A from which a product can be selected from the candidate products (ACT 15). Then, the product registration unit 102 waits until a product is selected from the product selection screen A (ACT 15; No).

In addition, in a configuration in which those candidate products with symbols are not displayed on the product selection screen A, the code recognition may continue to be executed (attempted) in the background of ACT 16. In this case, when a recognition result by code recognition is acquired while the product selection screen A is displayed, the product registration unit 102 may go ahead and execute the product registration by immediately proceeding to ACT 17 rather than waiting for an operator selection. When proceeding from the product selection screen A to ACT 17, it may be preferable to notify the customer of the reason for the screen transition by displaying a message such as “Symbol is recognized.”

In ACT 16, when a product is selected from the product selection screen A (ACT 16; Yes), the product registration unit 102 executes the product registration based on the product code of the selected product (ACT 17), and proceeds to ACT 18.

Next, the product registration unit 102 determines whether or not an operation of instructing the end of the product registration, in other words, an operation of instructing the start of the payment is performed (ACT 18). If no such operation is performed (ACT 18; No), the product registration unit 102 returns the process to ACT 11 to prepare for acquiring a new recognition result (next product registration). If the end operation is received (ACT 18; Yes), the product registration unit 102 ends this process and proceeds to the payment (ACT 8 in FIG. 10).

As described above, when a product cannot be uniquely specified by code recognition and the package recognition, the POS terminal 10 switches between continuing the code recognition and package recognition processing or displaying the product selection screen A according to whether or not a symbol is attached to the present candidate product with the highest degree of similarity. As a result, the POS terminal 10 can reduce the number of display occurrences of the product selection screen A during the product registration, thereby reducing the required number of times for the operator to perform selection operations on candidate products and increasing the efficiency of the product registration.

Furthermore, when a symbol is indicated as being attached to the candidate product with the highest degree of similarity, the POS terminal 10 continues the code recognition attempt (and the package recognition processing) and does not display the product selection screen A just yet. As a result, when there is a greater chance for the product to be specified by code recognition or the package recognition will achieve a unique identification, since the POS terminal 10 can let the code recognition (and the package recognition) continue, it is thus possible to more efficiently recognize and register the products overall.

It should be noted that the embodiments described above can be appropriately modified and implemented by changing various aspects of the configuration or functions of each of the devices described above. Certain modifications will be described as additional or other embodiments. In the following description, differences from the example embodiments already described above will be mainly described, and the detailed description of the elements, aspects, or operations overlapping with those already described may be omitted. Furthermore, the modifications described below may be implemented individually or in combination with each other as appropriate.

### Modification 1

In an embodiment, the display of the product selection screen A is controlled based on the symbol flag of the candidate product with the highest degree of similarity among the candidate products recognized through package (object) recognition, but the control conditions are not limited thereto.

For example, when the symbol flag of at least one candidate product recognized by the package recognition indicates “With Symbol”, the product registration unit 102 need not display the product selection screen A and may continue with the code recognition and the package recognition attempts.

For example, when the symbol flags of all candidate products recognized by the package recognition indicate “With Symbol”, the product selection screen A need not be displayed and the code recognition and the package recognition may continue. In addition, when the number of products among the candidates “With Symbol” in the symbol flag exceeds a predetermined threshold value, such as when the number exceeds the number of products “Without Symbol” among the candidate products recognized by package recognition, the product registration unit 102 need not display the product selection screen A and may continue the code recognition and the package recognition.

In this way, the POS terminal 10 switches between continuing the code recognition and the package recognition and displaying the product selection screen A according to the state of the symbol flags of the candidate products. Therefore, the POS terminal 10 can more flexibly switch the product registration method according to the candidate products recognized through the package recognition and can reduce the number of times the product selection screen A is displayed.

### Modification 2

In an embodiment, when the candidate product is recognized by the package recognition, the product master 142 determines, by reference to the symbol flag, whether or not a symbol is attached to the product. In this modification, it is determined whether or not a symbol is attached to the product based on information input by the operator or other information input besides the image captured by the imaging device 20.

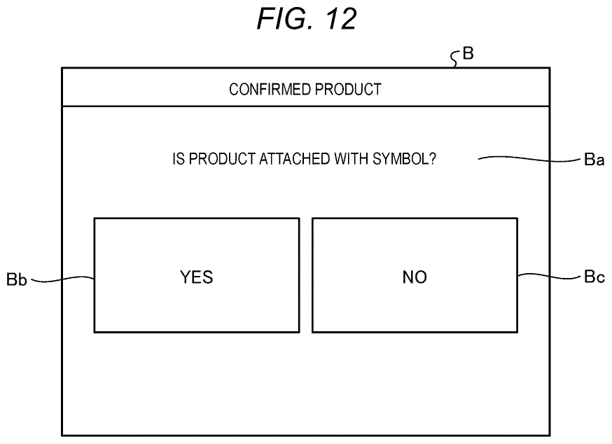

Specifically, when a plurality of candidate products are recognized through the package recognition, the product registration unit 102 according to this modification causes the display unit 16 to display a message or a confirmation screen for the customer to confirm or check whether or not a symbol is attached to the product. For example, the product registration unit 102 causes the display unit 16 to display a confirmation screen illustrated in FIG. 12.

FIG. 12 is a diagram illustrating an example of a confirmation screen displayed on the POS terminal 10. As illustrated in FIG. 12, a confirmation screen B includes a message Ba suggesting confirming whether or not the symbol is attached to the product, along with a YES button Bb and a NO button Bc for inputting the confirmation result.

Based on the confirmation screen B, the operator of the POS terminal 10 checks whether or not the product held up to the imaging device 20 has a symbol attached thereto and then inputs the confirmation result via the YES button Bb or the NO button Bc. When the product registration unit 102 receives an operation of the YES button Bb or the NO button Bc, the product registration unit 102 acquires the content of the operation as the confirmation result.

When the confirmation result indicates “With Symbol” (YES), the product registration unit 102 does not display the product selection screen A and waits until the product is identified by the code recognition (or the package recognition) for some predetermined amount of time. On the other hand, when the confirmation result indicates “Without Symbol” (NO), the product registration unit 102 causes the display unit 16 to display the product selection screen A based on the product information of the candidate product(s). In this case, the product registration unit 102 may be configured so as not to display on the product selection screen A any of the candidate products known to have symbols.

As a result, even when a candidate product is recognized, the POS terminal 10 can reduce the number of display occurrences of the product selection screen A. It is to be noted that in this modification, a confirmation screen B is displayed when a candidate product is recognized, but since a binary selection operation of YES or NO is performed on the confirmation screen B, the operation content is simpler compared to the selection operation performed on the product selection screen A. Further, even when the product selection screen A is displayed, since the range of candidates may be narrowed down to the candidate products “Without Symbol”, the operation for selecting the product can be more easily performed. Therefore, the POS terminal 10 of this modification can improve the efficiency of the product registration.

In addition, when the confirmation result indicates “With Symbol”, the product registration unit 102 determines whether or not there is only one candidate product among candidate products that has a “With Symbol” indicator, by reference to the symbol flag of each candidate product. In this case, when the product registration unit 102 determines that there is just one candidate product “With Symbol”, the product registration unit 102 may immediately execute the product registration based on the product code of this candidate product without waiting for the recognition result of the code recognition (or the package recognition).

Further, when the confirmation result indicates “Without Symbol”, the product registration unit 102 determines whether or not there is only one candidate product “Without Symbol”, by reference to the symbol flag of each candidate product. In this case, when the product registration unit 102 determines that there is just one candidate product “Without Symbol”, it may immediately execute the product registration based on the product code of this candidate product without displaying the product selection screen A.

### Modification 3

In an embodiment, the imaging device 20 performs the code recognition, but embodiments are not limited thereto, and the configuration in other examples may be such that the POS terminal 10 or the edge device 30 performs the code recognition.

For example, when the POS terminal 10 performs the code recognition, the image transmission unit 202 of the imaging device 20 transmits (outputs) an image to the POS terminal 10. The POS terminal 10 incorporates functions of the code recognition unit 203 executes the code recognition on the image transmitted from the imaging device 20.

For example, when the code recognition is performed by the edge device 30, the edge device 30 incorporates functions of the code recognition unit 203 and executes the code recognition on the image transmitted from the imaging device 20. In this case, the recognition result output unit 303 of the edge device 30 can output the recognition results of both code recognition and package recognition processes, starting with the recognition result that is obtained first.

In an embodiment, the edge device 30 performs the package recognition, but embodiments are not limited thereto, and the configuration in other examples may be such that the POS terminal 10 or the imaging device 20 performs this recognition.

For example, when the POS terminal 10 performs the package recognition, the image transmission unit 202 of the imaging device 20 transmits (outputs) an image to the POS terminal 10. Further, the POS terminal 10 incorporates functions of the package recognition unit 302 and executes the package recognition on the image transmitted from the imaging device 20.

When the imaging device 20 performs the package recognition, the imaging device 20 incorporates functions of the package recognition unit 302 and executes the package recognition on the image. In this case, the recognition result output unit 204 of the imaging device 20 outputs the recognition results of both the code recognition and package recognition, starting with the recognition result that is obtained first.

In an embodiment, the edge device 30 is described as a single device, but embodiments are not limited thereto, and the edge device 30 may be implemented as a cloud device (cloud computing) or the like formed of a plurality of information processing devices operating in conjunction or the like. Furthermore, in some examples, the store server 40 may incorporate the functions of the edge device 30.

### Modification 4

In an embodiment, the POS terminal 10 is a device operated by the customer himself/herself. However, embodiments are not limited thereto, and the POS terminal 10 may be a device operated by a store clerk. In this case, the imaging device 20 images the product based on the registration operation by the store clerk.

### Modification 5

In an embodiment, the POS terminal 10 has one imaging device 20 (or one imaging unit 25). However, embodiments are not limited thereto, and a plurality of imaging devices 20 (or imaging units 25) may be adopted. In such a case, the code recognition may be performed by each of the imaging devices 20 separately or may be performed by one imaging device 20. It is to be noted that it is preferable that the plurality of imaging devices 20 (or imaging units 25) be configured to image the product from different imaging positions so products can be imaged from multiple angles, so that it is possible to improve recognition speed and recognition rate.

It should be noted that the program executed by each device of the various embodiments (and modifications) can be installed in advance in the ROM, the storage unit, or the like of the device. The programs may be provided as a file in an installable format or an executable format recorded on a non-transitory, computer-readable recording medium such as a CD-ROM, a flexible disk (FD), a CD-R, or a Digital Versatile Disk (DVD).

A program executed by a device according to an embodiment may be stored on a computer connected to a network, such as the Internet, and downloaded via the network or otherwise accessed, provided, or distributed via such a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A product registration device, comprising:
a communication unit; and
a processor configured to:
receive a recognition result via the communication unit;
register a product corresponding to a product code as a sales target in a sales transaction if the recognition result specifies a single product code as the product being registered in the sales transaction;
when the recognition result specifies one or more candidate product codes for the product being registered in the sales transaction, identify a candidate product code in the recognition result having a highest degree of similarity value and check a product master database to determine whether the identified candidate product code is for a code-symbol attached product having a code symbol thereon; and
if the candidate product code having the highest degree of similarity value is for a code-symbol attached product, delay registration to permit another recognition result to be received via the communication unit.

2. The product registration device according to claim 1, wherein the product master database includes a code-symbol attached flag value associated with each product code.

3. The product registration device according to claim 1, wherein the processor is further configured to cause a display screen to display a confirmation screen when the identified candidate product code in the recognition result is determined to be a code-symbol attached product, the confirmation screen suggesting an operator check the product for a code symbol.

4. The product registration device according to claim 1, wherein
the recognition result indicates whether it was obtained by a code symbol reading or an image recognition processing, and
the processor is configured to wait for a predetermined time before displaying of a candidate selection screen if the recognition result was obtained by the image recognition processing.

5. The product registration device according to claim 1, wherein the processor is further configured to cause a candidate product selection screen to be displayed when the recognition result specifies one or more candidate product codes and the candidate product code having the highest degree of similarity value is not for a code-symbol attached product.

6. The product registration device according to claim 5, wherein the processor is further configured to cause the candidate product selection screen to include only candidate product codes for those products that are not code-symbol attached products.

7. A product registration system, comprising:
a point-of-sale terminal for registering products in a sales transaction;
an imaging device connected to the point-of-sale terminal and configured to provide a recognition result of a product being registered in the sales transaction; and
an edge device connected to the imaging device, the edge device configured to perform object recognition processing on images of the product from the imaging device, wherein
the point-of-sale terminal is configured to:
receive the recognition result from the imaging unit;
register a product corresponding to a product code as a sales target in the sales transaction if the recognition result specifies a single product code as the product being registered;
when the recognition result specifies one or more candidate product codes for the product being registered in the sales transaction, identify a candidate product code in the recognition result having a highest degree of similarity value and check a product master database to determine whether the identified candidate product code is for a code-symbol attached product having a code symbol thereon; and
if the candidate product code having the highest degree of similarity value is for a code-symbol attached product, delay registration to permit another recognition result to be received from the imaging unit.

8. The product registration system according to claim 7, wherein the product master database includes a code-symbol attached flag value associated with each product code.

9. The product registration system according to claim 8, wherein the product master database is stored on the point-of-sale terminal.

10. The product registration system according to claim 7, wherein the point-of-sale terminal is further configured to cause a display screen to display a confirmation screen when the identified candidate product code in the recognition result is determined to be a code-symbol attached product, the confirmation screen suggesting an operator check the product for a code symbol.

11. The product registration system according to claim 7, wherein
the recognition result indicates whether it was obtained by a code symbol reading by the imaging unit or an image recognition processing by the edge device, and
the point-of-sale terminal is configured to wait for a predetermined time before displaying of a candidate selection screen if the recognition result was obtained by the image recognition processing.

12. The product registration system according to claim 7, wherein the point-of-sale terminal is further configured to cause a candidate product selection screen to be displayed when the recognition result specifies one or more candidate product codes and the candidate product code having the highest degree of similarity value is not for a code-symbol attached product.

13. The product registration system according to claim 12, wherein the point-of-sale is further configured to cause the candidate product selection screen to include only candidate product codes for those products that are not code-symbol attached products.

14. The product registration system according to claim 7, wherein the edge device performs the object recognition using an object detection model, a feature extraction model, and a matching dictionary.

15. The product registration system according to claim 7, further comprising:
a store server connected to the point-of-sale terminal, wherein
the product master database is stored on the store server.

16. A product registration method, comprising:
receiving a recognition result via a communication unit;
registering a product corresponding to a product code as a sales target in a sales transaction if the recognition result specifies a single product code as the product being registered in the sales transaction;
when the recognition result specifies one or more candidate product codes for the product being registered in the sales transaction, identifying a candidate product code in the recognition result having a highest degree of similarity value and checking a product master database to determine whether the identified candidate product code is for a code-symbol attached product having a code symbol thereon; and
if the candidate product code having the highest degree of similarity value is for a code-symbol attached product, delaying registration to permit another recognition result to be received via the communication unit.

17. The product registration method according to claim 16, wherein the product master database includes a code-symbol attached flag value associated with each product code.

18. The product registration method according to claim 16, further comprising:
causing a display screen to display a confirmation screen when the identified candidate product code in the recognition result is determined to be a code-symbol attached product, the confirmation screen suggesting an operator check the product for a code symbol.

19. The product registration method according to claim 16, further comprising:
causing a candidate product selection screen to be displayed when the recognition result specifies one or more candidate product codes and the candidate product code having the highest degree of similarity value is not for a code-symbol attached product.

20. The product registration method according to claim 19, further comprising:
causing the candidate product selection screen to include only candidate product codes for those products that are not code-symbol attached products.
